(19) United States
(12) Patent Application Publication
(10) Pub. No.: US 2016/0192211 A1
(43) Pub. Date: Jun. 30, 2016

(54) CROSS-LAYER FRAMEWORK IN WIRELESS MESH NETWORK USING BIO-INSPIRED ALGORITHM AND OPERATION METHOD THEREOF

(71) Applicant: Korea Advanced Institute of Science and Technology, Daejeon (KR)

(72) Inventors: Hong Shik PARK, Daejeon (KR); Sang Hyun LEE, Daejeon (KR)

(21) Appl. No.: 14/621,118

(22) Filed: Feb. 12, 2015

(30) Foreign Application Priority Data
Dec. 24, 2014 (KR) 10-2014-0188412

(51) Int. Cl. H04W 24/02; H04W 72/04

(52) U.S. Cl. CPC H04W 24/02; H04W 72/04; H04W 84/18

(57) ABSTRACT

A cross-layer framework in a wireless mesh network using a bio-inspired algorithm and an operation method thereof are provided. The cross-layer framework includes a data structure configured to be formed in each node of the wireless mesh network and to collect and update information of each node through an ant packet and a cross-layer unit configured to perform at least one or more of channel assignment, routing, link scheduling, buffer management, and frame scheduling with respect to a control data flow of the data structure and to dynamically assign channels.

### CROSS-REFERENCE TO RELATED APPLICATIONS

A claim for priority under 35 U.S.C. §119 is made to Korean

Patent Application No. 10-2014-0188412 filed Dec. 24, 2014, in the Korean Intellectual Property Office, the entire contents of which are hereby incorporated by reference.

### BACKGROUND

Embodiments of the inventive concepts described herein relate to a cross-layer framework in a wireless mesh network (WMN) using a bio-inspired algorithm and an operation method thereof, and more particularly, to a cross-layer framework in a WMN using a bio-inspired algorithm and an operation method thereof to improve a network status measurement and a throughput in the WMN using an ant colony optimization (ACO) algorithm.

A WMN is a form of a multi-hop Ad Hoc network which receives traffics through the Internet or transmits traffics to the Internet. The WMN is a wireless network which includes mesh nodes and mesh clients

Herein, each of the mesh nodes performs an additional routing function which supports mesh networking as well as a typical routing function for gateway and bridge functions such as a typical wireless router. Each of the mesh nodes has minimum mobility and plays a pivotal role which forms a mesh backbone for mesh clients.

However, these configurations of the WMN have an influence on mesh capacity in the WMN due to interference caused from neighboring nodes in the WMN.

In Korean Patent No 10-1158974, a method of assigning channels in a wireless mesh node having multi-radio is provided. The description is given for a method of assigning a candidate channel selected by discriminating a channel status using channel status information and channel listening information of neighbor nodes in a certain hop, which are collected from the neighboring nodes.

However, there is a need to provide a framework for improving a network status measurement and a throughput in a WMN.

### SUMMARY

Embodiments of the inventive concepts provide a cross-layer framework in a WMN using a bio-inspired algorithm and an operation thereof to improve a network status measurement and a throughput in a WMN using an ACO.

Embodiments of the inventive concepts provide a cross-layer framework in a WMN using a bio-inspired algorithm and an operation thereof to reduce capital expenditures (CAPEX) and operational expenditures (OPEX) of a mesh network according to dynamic channel assignment and routing by using a cross-layer algorithm and an efficient data structure of mesh nodes in the WMN.

One aspect of embodiments of the inventive concept is directed to provide a cross-layer framework in a wireless mesh network (WMN) using a bio-inspired algorithm. The cross-layer framework may include a data structure configured to be formed in each node of the wireless mesh network and to collect and update information of each node through an ant packet and a cross-layer unit configured to perform at least one or more of channel assignment, routing, link scheduling, buffer management, and frame scheduling with respect to a control data flow of the data structure and to dynamically assign channels.

The data structure may include a global statistic information unit configured to store information of neighbor nodes to respective destination nodes and a local statistic information unit configured to store information of a current node.

The cross-layer unit may assign a channel when a frame of an input flow of data is a first frame in the wireless mesh network, may perform routing based on information about the channel of each interface, may verify whether a link activation time is exceeded in a link scheduling algorithm, may perform the link scheduling algorithm on the input flow when the link activation time is not exceeded, and may perform the buffer management and a frame scheduling algorithm.

The ant packet may include information about a source node and a destination node and information of nodes therebetween and may include fields for updating at least one or more of delay information, link quality information, and channel usage information, which are used in routing and the link scheduling algorithm. The ant packet may be sent to a destination node through an ant generator. The ant generator may generate a forward ant. The forward ant may collect information of intermediate nodes while moving to the destination node and may generate a backward ant. The backward ant may update information of intermediate nodes to its information while being retracing from the destination node to the source node.

The data structure may include a separate co-channel and interface, independent of a channel and interface for transmitting data, to measure a network status using the ant packet.

Another aspect of embodiments of the inventive concept is directed to provide a cross-layer operation method in a wireless mesh network (WMN) using a bio-inspired algorithm. The cross-layer operation method may include collecting and updating information of each node through an ant packet, in each node of the wireless mesh network and performing at least one or more of channel assignment, routing, link scheduling, buffer management, and frame scheduling with respect to a data flow of the information and dynamically assigning channels.

The dynamically assigning of the channel may include assigning a channel when a frame of an input flow of data is a first frame in the wireless mesh network, performing routing based on information about the channel of each interface, verifying whether a link activation time is exceeded in a link scheduling algorithm and performing the link scheduling algorithm on the input flow when the link activation time is not exceeded, and performing the buffer management and a frame scheduling algorithm on the input flow.

The cross-layer operation method may further include assigning the channel again after performing the buffer management and the frame scheduling algorithm on the input flow, when the link activation time is exceeded.

The collecting and updating of the information of each node may include generating a forward ant, which moves to a destination node, at an ant generator, based on information stored in a local statistic information unit of a source node to measure the information of each node using the ant packet, emerging from the source node to a network and then moving to a neighbor node at the generated forward ant, collecting local statistic information about the neighbor node through an ant processor when the neighbor node is not the destination node but an intermediate node, and emerging to the network and then moving to another neighbor node at the forward ant, generating a backward ant to update information of nodes of a passed path to its information at the forward ant when the neighbor node is the destination node, and retracing the passed path of the forward ant at the backward ant, entering an ant processor and updating information of a global statistic information unit of a node to information measured by the backward ant at the backward ant, when the backward ant reaches the node of the passed path, and emerging to the network and being then retraced to a previous node at the backward ant, and repeatedly updating information of each node to information measured by the backward ant until the backward ant returns to the source node.

The collecting and updating of the information of each node may include measuring a network status using the ant packet using a separate co-channel and interface, independent of a channel and interface for transmitting data.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a drawing illustrating a configuration of a cross-layer framework in a wireless mesh network using a bio-inspired algorithm according to an exemplary embodiment of the inventive concept;

FIG. 2 is a drawing illustrating a configuration of a data structure of each mesh node according to an exemplary embodiment of the inventive concept;

FIG. 3 is a flowchart illustrating a cross-layer operation method in a wireless mesh network using a bio-inspired algorithm according to an exemplary embodiment of the inventive concept;

FIG. 4 is a flowchart illustrating a data flow of a cross-layer framework according to an exemplary embodiment of the inventive concept;

FIG. 5 is a drawing illustrating a format of an ant packet according to an exemplary embodiment of the inventive concept; and

FIG. 6 is a drawing illustrating a co-channel use scheme for sharing information of a mesh node according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereinafter, a description will be given in detail for exemplary embodiments of the inventive concept with reference to the accompanying drawings.

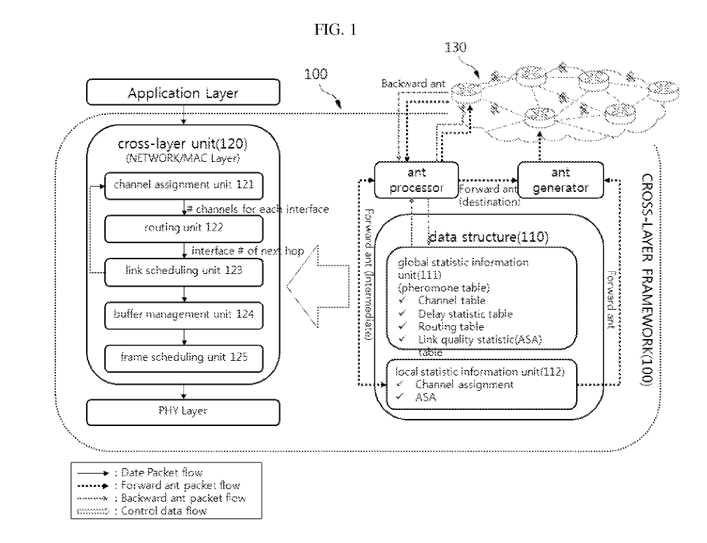

FIG. 1 is a drawing illustrating a configuration of a cross-layer framework in a wireless mesh network (WMS) using a bio-inspired algorithm according to an exemplary embodiment of the inventive concept.

Referring to FIG. 1, the cross-layer framework in the WMS using the bio-inspired algorithm which is an ant colony optimization (ACO) technology may be shown.

This cross-layer framework denoted by 100 in the WMS using the bio-inspired algorithm may include a data structure 110 and a cross-layer unit 120.

The data structure 110 may be formed in each node of the WMS, and may collect and update information of each node through an ant packet 130.

The data structure 110 may include a global statistic information unit 111 and a local statistic information unit 112.

The global statistic information unit 111 may store information of neighbor nodes to respective destination nodes.

The local statistic information unit 1120 may store information of a current node.

Herein, the ant packet 130 may include information about a source node and a destination node and information of nodes therebetween. The ant packet 130 may include fields for updating information about delay, link quality, channel usage and the like which are used in routing and a link scheduling algorithm. The ant packet 130 may be sent to the destination node through an ant generator.

The ant generator generates a forward ant. The forward ant may collect information of intermediate nodes while moving to a destination node. The forward ant may generate a backward ant. The backward ant may update information of intermediate nodes to its information while being retraced from the destination node to the source node.

The data structure 100 may include a separate co-channel and interface, independent of a channel and interface for transmitting data, to measure a network status using the ant packet.

The cross-layer unit 120 may perform at least one or more of channel assignment, routing, link scheduling, buffer management, and frame scheduling with respect to a control data flow of the data structure 110 and may dynamically assign channels.

In more detail, the cross-layer unit 120 may include at least one or more of a channel assignment unit 121, a routing unit 122, a link scheduling unit 123, a buffer management unit 124, and a frame scheduling unit 125.

When a frame of an input flow of data is a first frame in the WMN, the channel assignment unit 121 of the cross-layer unit 120 may assign a channel. The routing unit 122 may perform routing based on information about the channel of each interface.

Meanwhile, when the frame of the input flow is not the first frame, because a channel is previously assigned, the routing unit 122 may immediately perform routing.

The link scheduling unit 123 may verify whether a link activation time is exceeded in a link scheduling algorithm. When the link activation time is not exceeded, the link scheduling unit 123 may perform the link scheduling algorithm on the input flow. The buffer management unit 124 may perform buffer management. The frame scheduling unit 125 may perform a frame scheduling algorithm.

Herein, when the link activation time is exceeded, because a channel must be assigned again, the buffer management unit 124 and the frame scheduling unit 125 may perform buffer management and the frame scheduling algorithm on the input flow, respectively. The channel assignment unit 121 may assign a channel again.

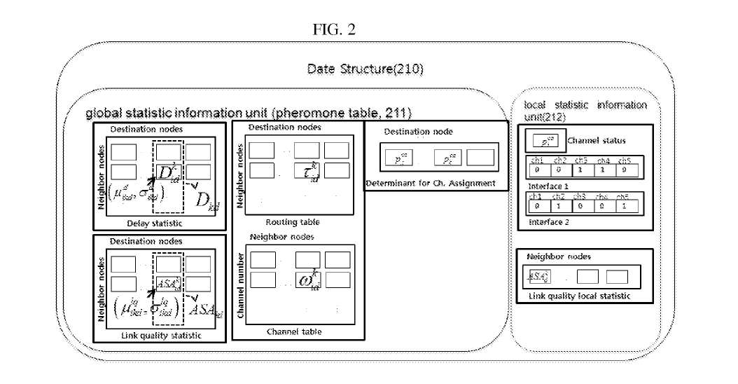

FIG. 2 is a drawing illustrating a configuration of a data structure of each mesh node according to an exemplary embodiment of the inventive concept.

Referring to FIG. 2, the data structure denoted by 210 may include a global statistic information unit 211 and a local statistic information unit 212.

The global statistic information unit 211 may include global statistic information, and may store information of neighbor nodes to respective destination nodes. In other words, the global statistic information unit 211 may store information of neighbor nodes according to destination nodes.

This global statistic information unit 211 may store pheromone table values of information used in routing and link/channel scheduling which will be described below.

The local statistic information unit 212 may include local statistic information, and may store information of its own node. In other words, the local statistic information unit 212 may store information of a current node.

The local statistic information unit 212 may store information about whether an interface (e.g., a network interface card (NIC)) currently uses any channel and link quality statistic (ASA) values for measuring statuses of links connected with neighbor nodes.

Herein, storing information necessary for another algorithm, the data structure 210 may add and delete the information.

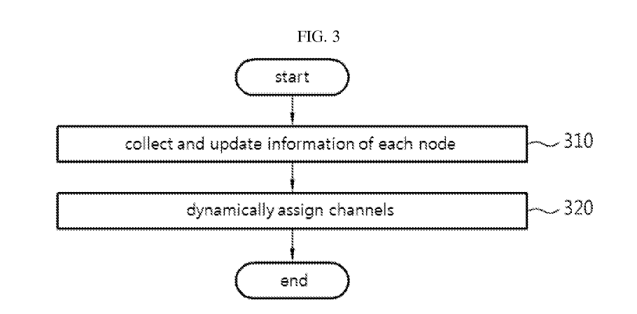

FIG. 3 is a flowchart illustrating a cross-layer operation method in a wireless mesh network (WMN) using a bio-inspired algorithm according to an exemplary embodiment of the inventive concept.

Referring to FIG. 3, a description will be given in detail for the cross-layer operation method in the WMN using the bio-inspired algorithm with reference to a cross-layer framework in the WMN using the bio-inspired algorithm of FIGS. 1 and 2.

In step 310, a data structure may collect and update information of each node through an ant packet in each node of the WMN.

In step 320, a cross-layer unit may perform at least one or more of channel assignment, routing, link scheduling, buffer management, and frame scheduling with respect to a data flow, and may dynamically assign channels.

A description will be given in detail for this.

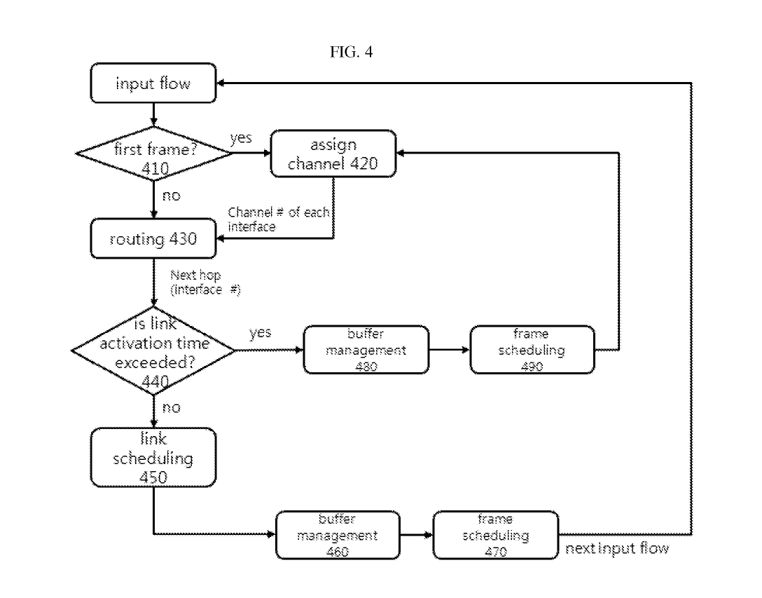

FIG. 4 is a flowchart illustrating a data flow of a cross-layer framework according to an exemplary embodiment of the inventive concept.

Referring to FIG. 4, a data flow of a cross-layer framework may be performed by a method of dynamically assigning channels. A description will be given in detail for the data flow using the cross-layer framework in a wireless mesh network (WMN) using a bio-inspired algorithm in FIGS. 1 and 2.

In step 410, it may be determined whether a frame of an input flow of data is a first frame in the WMN.

In step 420, when the frame of the input flow of the data is the first frame in the WMN, a channel assignment unit may assign a channel.

In step 430, a routing unit may perform routing based on information about the channel of each interface.

In step 440, a link scheduling unit may verify whether a link activation time is exceeded in a link scheduling algorithm.

In step 450, when the link activation time is not exceeded, the link scheduling unit may perform the link scheduling algorithm on the input flow.

In step 460, a buffer management unit may perform buffer management on the input flow. In step 470, a frame scheduling unit may perform a frame scheduling algorithm on the input flow.

When the link activation time is exceeded, the link scheduling unit must assign a channel again. Accordingly, in step 480, the buffer management unit may perform buffer management on the input flow. In step 490, the frame scheduling unit may perform the frame scheduling algorithm on the input flow. In step 420, the channel assignment unit may assign a channel again.

A data structure may collect and update information of each node through an ant packet in each node of the WMN.

In more detail, to measure information of each node using the ant packet, an ant generator may generate a forward ant, which moves to a destination node, based on information stored in a local statistic information unit of a local node (e.g., a source node).

Accordingly, the generated forward ant may emerge from the local node (e.g., the source node) to a network and may move to a neighbor node.

When the neighbor node is not a destination node but an intermediate node, the forward ant may collect local statistic information about the neighbor node through an ant processor, and may emerge to the network and move to another neighbor node.

Also, because the forward ant reaches the destination when the neighbor node is the destination node, to update information of nodes of a passed path, it may generate a backward ant. The backward ant may retrace the passed path of the forward ant.

Thereafter, reaching a node of the passed path, the backward ant may enter the ant processor and may update information stored in the global statistic information unit to information measured therein. The backward ant may emerge to the network and may be retraced to a previous node.

The backward ant may repeatedly update information of each node to information measured therein until it returns to a source node.

Herein, the data structure may include a separate co-channel and interface, independent of a channel and an interface for transmitting data, to measure a network status using an ant packet when collecting and updating information of each node.

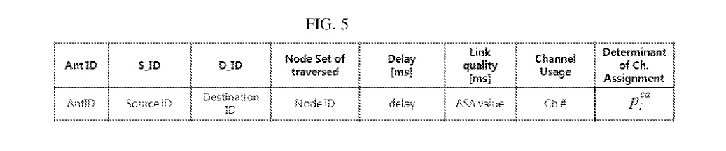

FIG. 5 is a drawing illustrating a format of an ant packet according to an exemplary embodiment of the inventive concept.

Referring to FIG. 5, the ant packet may include information

(Source ID) about a source node, information (Destination ID) a destination node, and information (Node ID) of nodes therebetween. The ant packet may include fields for updating information (delay, ASA value, Ch #, and Pₗ^{ca}) about delay, link quality, channel usage and the like which are used in routing and a link scheduling algorithm. The ant packet may be sent to the destination node through an ant generator (refer to FIG. 1).

The ant generator may generate a forward ant. The forward ant may collect information of intermediate nodes while moving to a destination node. The forward ant may generate a backward ant. The backward ant may update information of intermediate nodes to its information while being retracing from the destination node to the source node.

The cross-layer framework may perform not another algorithm of previously assigning channels but, as shown in FIG. 4, an algorithm of dynamically assigning channels.

FIG. 6 is a drawing illustrating a co-channel use scheme for sharing information of a mesh node according to an exemplary embodiment of the inventive concept.

Referring to FIG. 6, because a cross-layer framework dynamically assigns channels, it must be known that interfaces of each node use any channels.

If a channel and interface for measuring a network status using an ant packet and a channel and interface for transmitting data are used together, because a link between nodes is not formed, it is difficult to measure a network status.

Accordingly, a data structure (refer to FIG. 1) may include a separate channel and interface for measuring a network status. This channel may be referred to as a co-channel.

In other words, the data structure may include the separate co-channel and interface, independent of the channel and interface for transmitting data, to measure a network status using an ant packet, when collecting and updating information of each node.

Accordingly, because respective nodes use the same channel, interference occurs when each node simultaneously transmits an ant packet to neighbor nodes. Accordingly, it is preferable that each node transmits the ant packet one after the other.

For example, assuming that the entire period is “T”, each node may transmit an ant packet to neighbor nodes by “T/(# of node)” and all other nodes may receive the ant packet.

Therefore, the cross-layer framework in the wireless mesh network (WMN) using the bio-inspired algorithm and the operation method thereof according to embodiments of the inventive concept may improve a network status measurement and a throughput in the WMN using the ant colony optimization (ACO) algorithm.

Also, the cross-layer framework in the wireless mesh network (WMN) using the bio-inspired algorithm and the operation method thereof according to embodiments of the inventive concept may reduce capital expenditures (CAPEX) and operational expenditures (OPEX) of a mesh network according to dynamic channel assignment and routing by using a cross-layer algorithm and an efficient data structure of mesh nodes in the WMN.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. A cross-layer framework in a wireless mesh network using a bio-inspired algorithm, comprising:
a data structure configured to be formed in each node of the wireless mesh network and to collect and update information of each node through an ant packet; and
a cross-layer unit configured to perform at least one or more of channel assignment, routing, link scheduling, buffer management, and frame scheduling with respect to a control data flow of the data structure and to dynamically assign channels.

2. The cross-layer framework of claim 1, wherein the data structure comprises:
a global statistic information unit configured to store information of neighbor nodes to respective destination nodes; and
a local statistic information unit configured to store information of a current node.

3. The cross-layer framework of claim 1, wherein the cross-layer unit assigns a channel when a frame of an input flow of data is a first frame in the wireless mesh network, performs routing based on information about the channel of each interface, verifies whether a link activation time is exceeded in a link scheduling algorithm, performs the link scheduling algorithm on the input flow when the link activation time is not exceeded, and performs the buffer management and a frame scheduling algorithm.

4. The cross-layer framework of claim 1, wherein the ant packet includes information about a source node and a destination node and information of nodes therebetween and includes fields for updating at least one or more of delay information, link quality information, and channel usage information, which are used in routing and the link scheduling algorithm,
wherein the ant packet is sent to a destination node through an ant generator,
wherein the ant generator generates a forward ant,
wherein the forward ant collects information of intermediate nodes while moving to the destination node and generates a backward ant, and
wherein the backward ant updates information of intermediate nodes to its information while being retracing from the destination node to the source node.

5. The cross-layer framework of claim 1, wherein the data structure comprises:
a separate co-channel and interface, independent of a channel and interface for transmitting data, to measure a network status using the ant packet.

6. A cross-layer operation method in a wireless mesh network using a bio-inspired algorithm, comprising:
collecting and updating information of each node through an ant packet, in each node of the wireless mesh network; and
performing at least one or more of channel assignment, routing, link scheduling, buffer management, and frame scheduling with respect to a data flow of the information and dynamically assigning channels.

7. The cross-layer operation method of claim 6, wherein the dynamically assigning of the channel comprises:
assigning a channel when a frame of an input flow of data is a first frame in the wireless mesh network;
performing routing based on information about the channel of each interface;
verifying whether a link activation time is exceeded in a link scheduling algorithm and performing the link scheduling algorithm on the input flow when the link activation time is not exceeded; and
performing the buffer management and a frame scheduling algorithm on the input flow.

8. The cross-layer operation method of claim 7, further comprising:
assigning the channel again after performing the buffer management and the frame scheduling algorithm on the input flow, when the link activation time is exceeded.

9. The cross-layer operation method of claim 6, wherein the collecting and updating of the information of each node comprises:
generating a forward ant, which moves to a destination node, at an ant generator, based on information stored in a local statistic information unit of a source node to measure the information of each node using the ant packet;
emerging from the source node to a network and then moving to a neighbor node at the generated forward ant;
collecting local statistic information about the neighbor node through an ant processor when the neighbor node is not the destination node but an intermediate node, and emerging to the network and then moving to another neighbor node at the forward ant;
generating a backward ant to update information of nodes of a passed path to its information at the forward ant when the neighbor node is the destination node, and retracing the passed path of the forward ant at the backward ant;
entering an ant processor and updating information of a global statistic information unit of a node to information measured by the backward ant at the backward ant, when the backward ant reaches the node of the passed path, and emerging to the network and being then retraced to a previous node at the backward ant; and
repeatedly updating information of each node to information measured by the backward ant until the backward ant returns to the source node.

10. The cross-layer operation method of claim 6, wherein the collecting and updating of the information of each node comprises:
measuring a network status using the ant packet using a separate co-channel and interface, independent of a channel and interface for transmitting data.
